(19) United States
(12) Patent Application Publication
(10) Pub. No.: US 2010/0289368 A1
(43) Pub. Date: Nov. 18, 2010

(54) ALTERNATOR WITH ANGULARLY STAGGERED STATOR STAGES

(76) Inventor: Oreste Caputi, Napoli (IT)

Correspondence Address: VOLPE AND KOENIG, P.C., UNITED PLAZA, 30 SOUTH 17TH STREET, PHILADELPHIA, PA, 19103, US

(21) Appl. No.: 12/738,593

(22) PCT Filed: Oct. 20, 2008
(86) PCT No.: PCT/IB08/54317

§ 371 Date: Jun. 22, 2010

(30) Foreign Application Priority Data
Oct. 18, 2007 (IT) NA2007A000104

(51) Int. Cl. H02K 21/24

(52) U.S. Cl. 310/156.35

(57) ABSTRACT

A synchronous alternator is provided including a stator portion having one or more disc-shaped plates each carrying coils in multiples of three, and by a rotor portion, coaxial to the preceding, including one or more disc-shaped plates each carrying permanent magnets in a pair number different than the number of coils of each stator disc. Each of the magnets of each rotor disc being oriented with inverted poles with respect to the preceding one and a rotor disc is placed in between each stator disc so that the rotation thereof results in a variation of linked magnetic flux with the coils, determining, the generation of alternated electrical current with variable frequency, so that the braking effect on the first coil is completely or partially balanced by an accelerating effect determined on the second coil.

### FIELD OF INVENTION

The present invention is related to a synchronous-kind alternator, having a staged structure wherein the respective stators are angularly staggered to each other. They are of the kind which can be used for instance for the generation of electrical power if connected to a turbine rotating at low rate, particularly a wind turbine.

### BACKGROUND

The synchronous alternators are generally formed by rotor bodies with an approximately cylindrical shape, housing respective magnets, the rotation thereof occurring inside respective stators each comprising electrical coils wherein the circulation of electrical current is induced.

Alternatively, alternators are known wherein the magnets are distributed on the surface of a rotating disc close to a stator disc carrying induction coils, such discs being faced to each other.

The above mentioned synchronous alternators have the drawback of a remarkable braking effect when the rotor stacking is stopped, determined at the breakaway by the attraction among magnets and the respective ferrous cores of the coils, the latter being placed at a dead point wherein there is a peak of attraction due to the coincidence of the axes of the magnets and of the ferrous cores.

Generally, the permanent magnet synchronous generators are categorized according to the flux distribution in the magnetic circuit, and have a radial flux configuration (RFPM), an axial floe configuration (AFPM) or a transversal flux configuration (TFPM).

In the radial flux configuration (RFTM), the flux lines radially get out of the rotor, following the permanent magnets, and form a loop on parallel planes with respect to the rotation direction. In a conventional layout, permanent magnets are provided on the rotor, and induction windings on the stator. Other embodiments are provided with: surface magnets, e.g. of the Nd—Fe—B type or simpler; embedded magnets, e.g. in ferrite; inner or outer rotors, the latter embodiment allowing a pressing effect of the centrifugal force, an eased cooling of the rotors, the turbine blades mounted directly on the outer surface of the generator; lap winding or single winding type (single-coil).

In the axial flux configuration (AFPM) the flux lines develop in parallel to the rotation axis of the machine. The conventional configuration is toroidal, with an inner stator, a toroidal core with no slots and with a winding preventing the so called “cogging torque”, implying a high air gap and leakage flux, double outer rotor with permanent magnets involving a high torque density, a high cost, an eased magnet cooling. A disc configuration is also known, with double outer stator (with or without slots, eased winding cooling) and inner rotor with permanent magnets.

In the transversal flux configuration (TFPM) the flux lines form a loop in planes perpendicular to the rotation direction. The stator has ring coils with U-shaped ferromagnetic members; the rotor has permanent magnets. The mono-phase scheme has three mono-phase stator and a rotor with three appropriately staggered rows of surface magnets or with flux concentrators; winding simplicity (no leakage flux). The configuration involves a weight reduction but also a difficult mechanical construction.

### SUMMARY

The present invention scope is to provide a synchronous alternator allowing to obviate to the above listed drawbacks, as defined in the annexed claim 1 and in the following claims.

### BRIEF DESCRIPTION OF THE DRAWINGS

In the following, two embodiment of an alternator according to the present invention will be disclosed, to an exemplificative and non limitative purpose, with reference to the annexed drawings wherein:

FIG. 1 shows a first embodiment as a whole, of an alternator according to the invention, identifying the stator and the rotor parts.

FIG. 2 shows the stator and rotor stackings of the alternator of FIG. 1, with the representation of the staggering angles of the stator disc and the axial alignment of the rotor discs.

FIG. 3 shows the coil distribution within the single stator discs and the alternate layout of the magnets within the rotor discs in the alternator of FIG. 1.

FIG. 4 shows the stator disc support in the alternator of FIG. 1.

FIG. 5 shows the coil polar sequence, the stator coil composition, the sectioned cylindrical surface on which the winding axes of the coils of the alternator of FIG. 1 lie, the development thereof being used for representing the straightening of the coil polar sequence.

FIG. 6 shows the star shaped connection of the phases of a single stator disc in the alternator of FIG. 1;

FIG. 7 shows the magnet polar sequence, the orientation of the main magnetic flux of the single magnet, the sectioned cylindrical surface of the alternator of FIG. 1, on which the axes of the magnetic fluxes of the magnets lie, the development thereof being used for representing the straightening of the magnet polar sequence in FIG. 8.

FIG. 8 shows the straightening of the coil polar sequence and the straightening of the magnet polar sequence within the alternator of FIG. 1, to visualize the staggering of the stator coils.

FIG. 9 shows a second embodiment according to the invention, wherein the stator and the rotor parts are identified.

FIG. 10 shows the stator sectors within a stator disc of the alternator of FIG. 1, with the representation of the staggering angles.

FIG. 11 shows a detail of the stator of FIG. 10.

### DETAILED DESCRIPTION OF THE PREFERRED EMBODIMENTS

The first embodiment of the invention concerns an axial flux synchronous alternator 1000 (AFPM) composed by a stator stacking 100 comprising a modular series of one or more disc-shaped identical plates, stacked and forming stator discs 101, each having a polar sequence 107 of identical coils 102, in a number multiple of three, and by a rotor stacking 200 coaxial to the latter, comprising two or more stacked disc-shaped plates, forming rotor discs 201, each having a polar sequence 207 of identical permanent magnets 202, in a number pair and different (greater or lower) than the number of coils 102 in each stator disc 101.

The stator coils 102 have turns arranged with winding axis 106 parallely oriented with respect to the alternator axis 300.

Within each rotor disc 201, each magnet 202 is arranged with the main flux 209 thereof oriented axially, with inverted poles with respect to those of the preceding magnet. Within the stacking 200 of rotor discs, the single rotor discs are arranged in an angularly aligned position, i.e. each magnet 202 of each rotor disc 201 is positioned exactly above the homologous magnet of the subsequent rotor disc e with an orientation concordant with the main magnetic flux.

Such a configuration realizes a polar distribution of alternated linked axial magnet fluxes 232, in a number equal to that of the magnets of each rotor disc, starting from the rotor disc up to the end rotor disc of the rotor stacking. Between each rotor disc and the subsequent a stator disc 101 is arranged, so that the rotation of the stacking 100 of rotor discs, and then of alternated linked axial magnetic fluxes 232 result in a variation of the linked magnetic flux within the ferrous cores 105 of the coils of the stator discs, resulting in, within each stator disc, the generation of alternated electrical current 701 with variable frequency, with a frequency function of the rotation rate.

Two adjacent stator discs have the same structural configuration, but the support 103 thereof is such that to allow the positioning of two adjacent stator discs 101 in a manner such that the angular position thereof be out of alignment within the same axis 300.

Such a disposition results in that each coil 102 is arranged angularly staggered with respect to the homologous coils of the subsequent stator disc. In such a way, the ferrous core 105 at the axis of each coil of a stator disc establishes a reciprocal attraction with the closer linked axial magnetic flux 232.

The attraction effect f the single ferrous core is in part nullified by the attraction within the same flux 232, undergone by the ferrous core of the homologous staggered coils because belonging to another stator disc.

When the rotor discs are moving, it results in an absence of relevant phenomena of pulsating braking actions due to the attraction between linked axial magnetic fluxes and coil ferrous cores, such absence is obtained thanks to the fact that each coil, within the stator stacking, is arranged in an angularly staggered manner with respect to any other coil. In such a way, the braking effect, related to the overcoming of the axial alignment between a coil and a linked axial magnetic flux 232, is completely or partly balanced by a pulling effect determined by the reaching of the axial alignment between a homologous coil and the same linked axial magnetic flux.

The axial flux alternator 1000 object of the present invention prevent said braking effect both in the static and the dynamic phase. As a matter of fact, when the rotor discs are staggered and an external event excites the rotational movement, the absence of relevant braking action phenomena due to the attraction between linked axial magnetic fluxes 232 and ferrous cores 101 of the coils 102 is such that the effect of “first start friction” determining the braking force at the start of the rotation itself is reduced to a minimum.

The alternator 1000 is designed according to a modular building technique with stators appropriately axially stacked, whereby the arrangement of the corresponding coils is staggered. It is possible to achieve, in the obtained stator distribution with still rotor discs, a dead point characterized by an unstable balance between attraction forces caused through linked axial magnetic fluxes and coil ferrous cores.

In this way, it is possible to achieve, for some linked axial magnetic fluxes, an attraction effect clockwise, while for others an attraction counterclockwise, so that the two effects annul themselves, almost completely preventing the drawback of the braking effect at the rotor stacking 200 still. The result is a marked decrease of the passive resistances at a very low rotation rate, and with the absence of relevant phenomena of pulsated braking actions, when the rotation is started, with a remarkable increase of the machine overall efficiency.

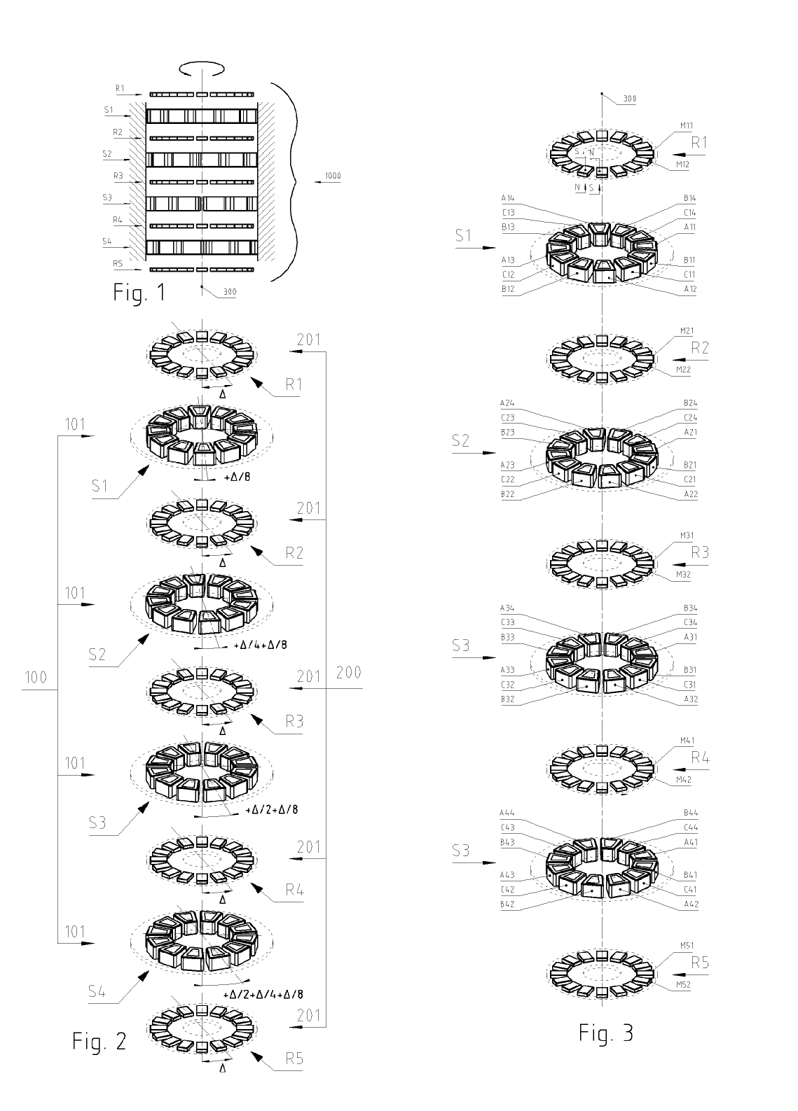

FIGS. 1, 2 and 3 illustrate the present invention in the preferred arrangement thereof, comprising an alternator 1000 composed by 5 rotor discs 201 singularly indicated as R1, R2, R3, R4, R5 respectively, and 4 stator discs 101 singularly indicated as S1, S2, S3, S4. Each of the rotor discs is identical to the adjacent and is positioned in such a way the single magnets can be overlapped, because they have the axial magnetic fluxes 232 linked.

Each rotor disc 201 caries magnets mentioned as follows:

M1=magnet 202 on the rotor disc R1
M11=magnet on the rotor disc R1, at the first place
Each stator disc carries coils, in a number different to that of the magnets, mentioned according to the following criterium:
A=coil generating the phase A of a tree-phase current.
A1=A type coil placed at he stator disc S1
A11=A type coil placed at he stator disc S1 placed at position 1 of a coil sequence linked to each other in a series.

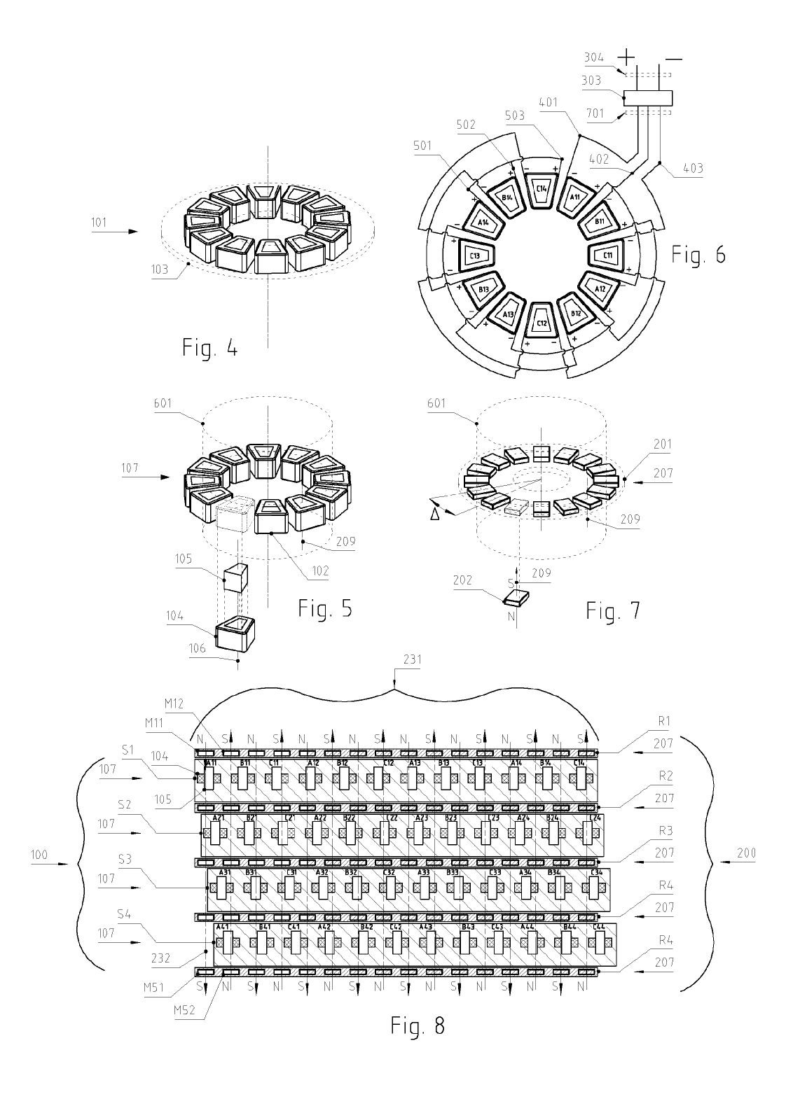

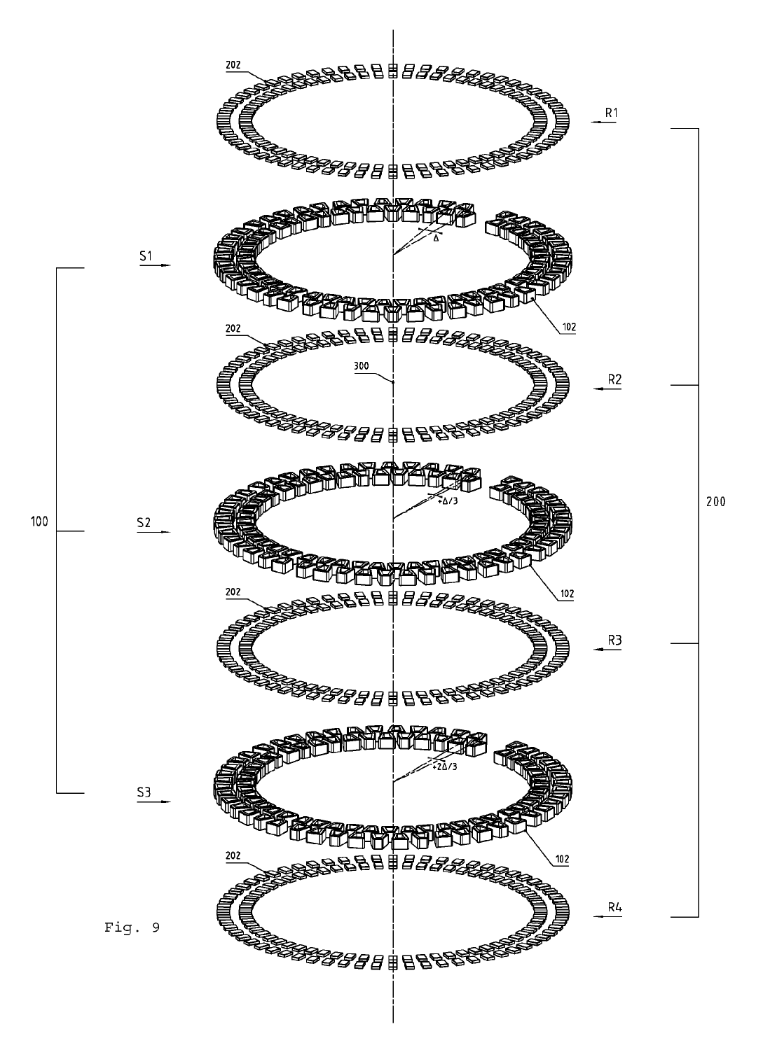

From FIG. 1 to FIG. 8, making reference to coil A12, it can be seen that the corresponding coil A22 of the stator disc S2 is positioned with a certain shift from the vertical axis of coil A12. In the same way, coil A32 with respect to coil A 22 and so on, coil A42 with respect to coil A32.

With reference t stator S1 and to coil A12, when the rotor stacking 200 is still, some coils have the ferrous core thereof so as to be attracted to the right by the linked axial magnetic flux 232 from magnets M11, M21, M31, M41, M51, but such an attraction, being in inverse proportion with the square of the distance between the axis of the ferrous core and the axis of the linked magnetic flux, is annulled by the attraction determined on the other coil to the left by the linked axial magnetic flux 232 from magnets M12, M22, M32, M42, M52, by virtue of the staggering.

Therefore, it is prevented that the linked magnetic flux is reciprocally stopped by the attraction on a series of ferrous cores aligned of a perfectly aligned coils (not concerned to the present invention), causing the stop of the alternator, or anyway a strong friction at the first start, or phenomena of pulsating braking action due to the attraction between linked axial magnetic fluxes and coil ferrous cores.

Such drawback is prevented by the fact that the number of magnets on a rotor disc is different than the number of the coils with ferrous core placed on a stator disc. With reference to the stator disc S1, the coils applied thereto are part of the phase groups A, B, C. The phase groups are formed in the following manner: phase group A of the stator disc S1 composed by coils indicated as A11, A12, A13 and A14, linked together in a series and having a start 401 and an end 501; phase group B of the stator disc S1 composed by coils indicated as B11, B12, B13 and B14 linked together in a series and having a start 402 and an end 502; phase group C of the stator disc S1 composed by coils indicated as C11, C12, C13 and C14, linked together in a series and having a start 403 and an end 503.

The single phase groups (FIG. 6) are linked to each other through a star arrangement joining the ends 501, 502 and 503 and achieving at the starts 401, 402 and 403 a three-phase alternate current 701, with variable frequency according to the rotation rate of the rotor stacking 200, then straightened by a straightening bridge 303 at the output thereof a continuous current 304 is obtained with variable voltage. The description above is suitable for the stator discs S2, S3, S4.

The continuous current 304 with variable voltage produced by S1 is combined with the analogous currents, produced by the other stators of the stacking. Among the possible combinations, the following are considered:

1. Combining in a series the contribution of potential coming from S1, S2, S3, S4 obtaining the potential “Va”. Such arrangement confers a very low rotation rate of cut-in, suitable for the use with low rotation rates, i.e. when the alternator is used for the production of electrical energy from a wind source in regions with lower speed winds and irregular winds.
2. Combining the contribution from S1 in a series with the contribution from S2 achieving a potential V12. Analogously, the continuous current produced by S3 is combined in a series with the contribution from S3 achieving the potential V34. The two potentials V12 and V34 are combined in parallel, achieving the potential Vb, so as to double the intensity if the usable electrical current. Such an arrangement confers a low rate of cut-in and optimizes the machine at any condition of operation, i.e. when the alternator is used for the production of electrical energy from a wind source in regions characterized by constant wind, at average intensity.
3. Combining in parallel the contribution of potential from 51, S2, S3, S4 obtaining a potential Vc. Such arrangement confers a high speed of cut-in, suitable for the use with high rotational rate, i.e. when the alternator is used for the production of electrical energy from a wind source in regions characterized by high intensity wind, possibly irregular.
The continuous current achieved with potentials Va, Vb, Vc can be both adjusted to be used for cell recharging and converted by a suitable inverter in mono-phase alternate current used to be exchanged with the electrical network.

With reference to FIGS. 9 to 11, a second embodiment of the alternator according to the invention is an axial flux synchronous alternators (AFPM) composed by a stator composition 100 and by a rotor composition 200.

The stator composition 100 comprises a modular series of one or more disc-shaped plates S1, . . . , Sn identical and axially stacked and angularly staggered according to the arrangement of the previous embodiment.

Each plate S comprises a modular series of one or more stator sectors P arranged on one or more concentric rings. Each stator sector P carries a regular polar sequence 901 of coils 102 identical to each other, in a number multiple of three. The angle of the stator sector is determined by the number of sectors, by the number of coils and by the diameter of the polar sequence. The rotor composition 200, coaxial to the previous 100, comprises one or more identical disc-shaped plates called rotor discs R, each one carrying one or more regular polar sequence of permanent magnets 2002, in a pair number, different (greater or lower) to the number of coils 102 comprised in each stator disc S. the coils 102 have turns arranged with the windings axis parallely oriented to the axis 300 of the alternator.

Within each rotor disc R, each magnet 202 is arranged with the main flux thereof oriented according to the axis and with inverted poles with respect to those of the previous magnet. Within the stacking of stator discs 200 the single rotor discs are arranged according to an aligned angular position, i.e. each magnet 202 of each rotor disc R is positioned exactly aligned with the corresponding magnet of the subsequent coaxial rotor disc.

Such arrangement realizes a polar distribution of alternated linked axial magnetic fluxes, in a number equal to the number of magnets in each rotor disc, starting from the head rotor disc to the tail rotor disc of the rotor stacking. Between each rotor disc and the subsequent, a stator disc S is placed so as the rotation of the stacking 100 of rotor discs, and hence of the alternated linked axial magnetic fluxes, result in a variation of the linked magnetic flux within the ferrous cores of the coils of the stator sectors P, causing, within each stator disc sector, the generation of alternated electrical current 701 at variable frequency, with a frequency function of the rotation rate.

Two adjacent stator discs have the same structural configuration, but the support thereof is such that to allow the positioning of two subsequent stator sectors P in a manner such that the angular position thereof be out of alignment within a regular polar sequence on the same axis 300.

Such a disposition results in that each coil 102 is arranged angularly staggered with respect to the homologous coils of the subsequent stator disc. In such a way, the ferrous core 105 at the axis of each coil of a stator disc establishes a reciprocal attraction with the closer linked axial magnetic flux.

The attraction effect of the single ferrous core is in part nullified by the attraction within the same flux, undergone by the ferrous core of the homologous staggered coils because belonging to another stator disc.

This improves the performance of the alternator at the starting of the rotation and at a low rotation rate because, when the rotor discs are at a minimum movement, underlines the absence of relevant phenomena of pulsating braking actions due to the attraction between linked axial magnetic fluxes and coil ferrous cores. Such absence is obtained thanks to the fact that each coil, within the stator stacking, is arranged in an angularly staggered manner with respect to any other coil. In such a way, the braking effect, related to the overcoming of the axial alignment between a coil and a linked axial magnetic flux, is completely or partly balanced by a pulling effect determined by the reaching of the axial alignment between a homologous coil and the same linked axial magnetic flux.

It is possible to achieve, in the obtained stator distribution, with still rotor discs, a dead point characterized by an unstable balance between attraction forces determined between the linked axial magnetic fluxes and the coil ferrous cores. In this way, it is possible to achieve, for some linked axial magnetic fluxes, an attraction effect clockwise, while for others an attraction counterclockwise, so that the two effects annul themselves, almost completely preventing the drawback of the braking effect at the rotor stacking 200 still. The result is a marked decrease of the passive resistances at a very low rotation rate, and with the absence of relevant phenomena of pulsated braking actions, when the rotation is started, with a remarkable increase of the machine overall efficiency.

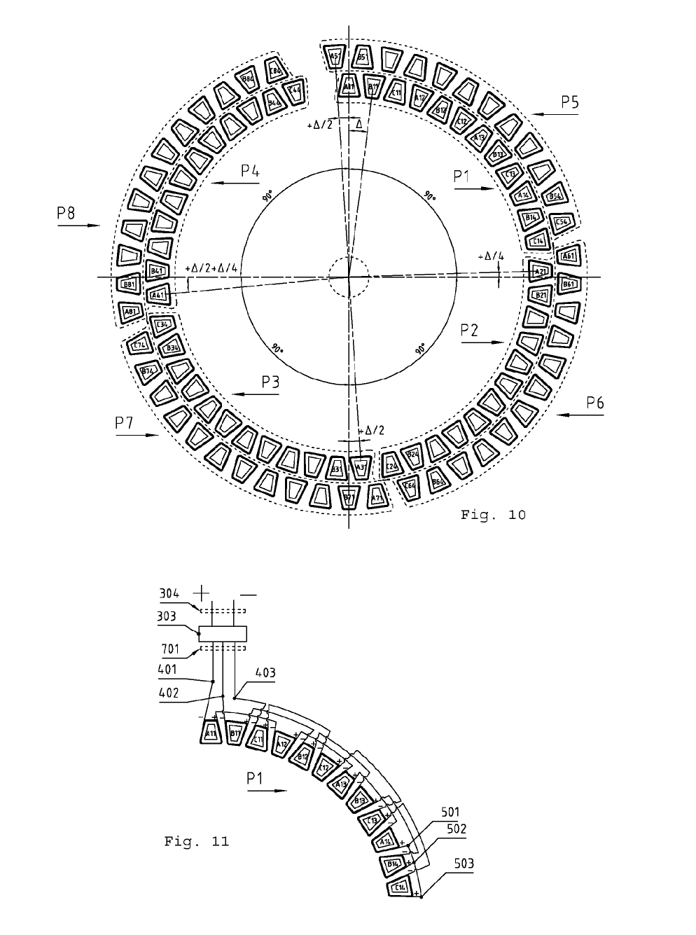

FIGS. 10 and 11 describe this alternator in the preferred configuration thereof, comprising an alternator composed by a rotor disc, which is indicated as R1 and a stator disc S1 which is divided in 8 sectors of stator discs indicated as P1, P2, P3, P4, P5, P6, P7, P8.

Each rotor disc 201 carries magnets arranged according to two concentric annuli, each characterized by a regular polar sequence of magnets.

Each stator disc carries coils, in a number different to that of the magnets, mentioned according to the following criterion:

A=coil generating the phase A of a tree-phase current.
A1=A type coil placed at he stator disc S1
A11=A type coil placed at he stator disc S1 placed at position 1 of a coil sequence linked to each other in a series.

From FIG. 10, making reference to coil All of the sector P1 of the stator disc, it can be seen that the corresponding coil A21 of the sector P2 of the stator disc is positioned with a certain angular shift from the vertical axis of coil A12. In the same way, coil A31 with respect to coil A 21 and so on, coil A41 with respect to coil A31.

With reference to stator S1 and to coil A12, when the rotor stacking 200 is still, some coils have the ferrous core thereof so as to be attracted to the right by the linked axial magnetic flux from magnets present according to the regular polar sequence on the rotor disc while other coils, in a number equal to the first, have the ferrous core hereof so as to be attracted to the left. Therefore, it is prevented that the magnetic flux is reciprocally blocked by attraction on the same axis on a series of aligned ferrous cores because the latter do not lie on a regular polar sequence of stator sectors P.

With reference to the sector P1 of the stator disc, the coils applied thereto are part of the phase groups A, B, C. The phase groups are formed in the following manner: phase group A of the stator disc S1 composed by coils indicated as A11, A12, A13 and A14, linked together in a series and having a start 401 and an end 501; phase group B of the stator disc S1 composed by coils indicated as B11, B12, B13 and B 14 linked together in a series and having a start 402 and an end 502; phase group C of the stator disc S1 composed by coils indicated as C11, C12, C13 and C14, linked together in a series and having a start 403 and an end 503.

The single phase groups (FIG. 11) are linked to each other through a star arrangement joining the ends 501, 502 and 503 and achieving at the starts 401, 402 and 403 a three-phase alternate current 701, with variable frequency according to the rotation rate of the rotor stacking 200, then straightened by a straightening bridge 303 at the output thereof a continuous current 304 is obtained with variable voltage. The description above is suitable for the sectors P2, . . . , P8 of the stator discs.

The continuous current 304 with variable voltage produced by S1 is combined with the analogous currents, produced by the other stators of the stacking. Among the possible combinations, the following are considered:

1. Combining in a series the contribution of potential coming from P1, P2, P3, P4, P5, P6, P7, P8 obtaining the potential “Va”. Such arrangement of alternator, directly connected to the axis of a wind turbine, realizes a multiplier without gears conferring a very low rotation rate of cut-in, suitable for the use with low rotation rates, i.e. when the alternator is used for the production of electrical energy from a wind source in regions with lower speed winds and irregular winds.
2. Combining the contribution from P1, P2, P3, P4 in a series a potential V1 is obtained. Analogously, combining the contribution from P5, P6, P7, P8 in series a potential V12 is achieved. The two potentials V1 and V are combined in parallel, achieving the potential Vb, so as to double the intensity of the usable current. Such an arrangement confers a low rate of cut-in and optimizes the machine at any condition of operation, i.e. when the alternator is used for the production of electrical energy from a wind source in regions characterized by constant wind, at average intensity.
3. Combining in parallel and/or in series the contribution of potential from P1, P2, P3, P4, P5, P6, P7, P8 obtaining a potential Vc in a flexible manner, so as to optimize the efficiency of the wind generator in function of any inverter, any turbine, any site.

The continuous current achieved with potentials Va, Vb, Vc can be both adjusted to be used for cell recharging and converted by a suitable inverter in mono-phase alternate current used to be exchanged with the electrical network.

The embodiments of alternators disclosed herein all have the peculiarity that each stator produces three phase alternate current never in phase with that produced by the other stators of the same alternator.

Having described some embodiments of the present invention, it is clarified that not only such embodiments should be protected, but the protection extends to all the embodiments which can be carried out applying the outstanding features, as defined by the following claims.

1. Alternator of the synchronous type, having a staged structure wherein the respective stators are angularly staggered, comprising:
a stator stacking (100) comprising a modular series of one or more disc-shaped plates stacked according to an axis (300), forming stator discs (101);
a rotor stacking (200) coaxial to the preceding stator stacking (100) comprising one or more disc-shaped plates stacked, forming rotor discs (201);
wherein two adjacent stator discs (101) have the same structural arrangement and each one carries one or more polar sequences (107) of coils (102) identical to each other, and wherein the coils (102) have turns arranged with a winding axis (106) oriented in parallel to the axis (300) of the alternator, each of said coils (102) comprising a winding (104) of conductive material (104) and a ferrous core (105) positioned at a winding axis (106) of the winding (104), said coils (102) of each stator disc (101) being in a number multiple of three
wherein each stator disc (101) is out of alignment, at the same axis (300), with respect to other stator discs (101) of the same stator stacking (100) and hence each coil (102), within the stator stacking (100), is arranged in an angularly staggered manner with respect to any other coil of the stator stacking.

2. Alternator according to claim 1, wherein two adjacent stator discs (101) have an angle (120) of mutual staggering within the stator stacking (100), the value thereof is equal to an angle (220) comprised between two adjacent magnets (202) of the rotor disc (201) divided by the number of stator discs (101) in the stator stacking (100).

3. Alternator according to claim 2, wherein the mutually staggered position of the stators implies that the generated electrical currents from each stator are not in phase to each other.

4. Alternator according to claim 1, wherein two adjacent rotor discs have the same structural configuration and each of them carries a polar sequence (207) of permanent magnets (202) identical to each other and in a pair number, so as each of them is oriented with inverted poles with respect to the preceding one and it is oriented with the magnetic axis (206) thereof in parallel with the rotation axis (300) of the rotor disc.

5. Alternator according to claim 1, wherein the rotor discs (201) comprise magnets in a pair number and different from the number of coils (102) in each stator disc (101).

6. Alternator according to claim 1, comprising rotor discs (201) arranged in an angularly aligned position, i.e. each magnet of each rotor disc is positioned exactly above the corresponding magnet of the subsequent rotor disc and with a concordant orientation, so as to realize a polar distribution (231) of linked axial magnetic fluxes (232) alternated, in a number equal to that of the magnets in each polar series (207) within each rotor disc, starting from a head rotor disc up to a tail rotor disc of the rotor stacking (200).

7. Alternator according to claim 1, wherein between each rotor disc (202) and a subsequent one, a stator disc (102) is placed, so that a rotation of the stacking of rotor discs, and hence of linked axial magnetic fluxes (232) alternated, results in a variation of linked magnetic flux within ferrous cores of the coils, determining, within each statoric disc, the generation of alternated electrical current with variable frequency, with a frequency function of the rotation rate.

8. Alternator according to claim 1, wherein between each stator disc (102) and the subsequent one a rotor disc is placed, so that the rotation of the stacking of the rotor discs, and hence of linked axial magnetic fluxes (232) alternated, results in a variation of linked magnetic flux within ferrous cores of the coils, determining, within each statoric disc, the generation of alternated electrical current with variable frequency, with a frequency function of the rotation rate.

9. Alternator according to claim 1, comprising stator discs (101) wherein the coils are divided in three groups of phase, each of them comprising a number of coils equal to the number of coils composing the polar sequence (107) divided by three.

10. Alternator according to claim 9, wherein the three groups of phase of the same stator disc are combined by a star connection obtaining a three-phase alternate current (701) of frequency variable with the rotation rate of the rotor stacking (200).

11. Alternator according to claim 10, wherein the three-phase alternated current (701) produced by each stator disc is transformed in continuous current (304) with variable potential by a straightening bridge (303).

12. Alternator according to claim 11, wherein the continuous current (304) with variable potential of a stator disc (101) is combined in series with the continuous current with variable potential of another stator disc (101) of the same stator stacking (100).

13. Alternator according to claim 12, wherein the continuous current with variable potential of a stator disc (101) is combined in parallel with the continuous current with variable potential of another stator disc (101) of the same stator stacking (100).

14. Alternator of the synchronous type, having a staged structure wherein the respective stators are angularly staggered, comprising:
a stator stacking (100) comprising a modular series of one or more disc-shaped plates stacked according to the axis (300), forming stator discs (101);
a rotor stacking (200) coaxial to the preceding stator stacking (100) comprising one or more disc-shaped plates stacked, forming rotor discs (201);
wherein two adjacent stator discs (101) have the same structural arrangement and each one carries one or more polar concentric sequences of stator sectors comprising coils (102) identical to each other, and wherein the coils (102) have turns arranged with a winding axis (106) oriented in parallel to the axis (300) of the alternator, each of said coils (102) of each stator sector being in a number multiple of three,
wherein each sector of stator disc (101) is not arranged in a regular polar series, within the same axis (300) and hence each coil (102), within the stator disc (100), is arranged in an angularly staggered manner with respect to any other coil of the stator disc.

15. Alternator according to claim 14, wherein two adjacent sectors (P) of stator disc have an angle of mutual staggering within the non regular polar sequence, the value thereof is equal to a fraction of the angle (Δ) comprised between two adjacent coils (102) of each sector (S) of stator disc.

16. Alternator according to claim 15, wherein the mutually staggered position of the stators implies that the generated electrical currents from each stator are not in phase to each other.

17. Alternator according to claim 16, wherein the denominator of the fraction of the angle (Δ) is equal to the number of sectors in the non regular polar sequence.

18. Alternator according to claim 14, wherein two adjacent rotor discs (R) have the same structural configuration and each of them carries a polar sequence of magnets (202) identical to each other and in a pair number, so as each of them is oriented with inverted poles with respect to the preceding one and it is oriented with the magnetic axis (206) thereof in parallel with the rotation axis (300) of the rotor disc.

19. Alternator according to claim 18, wherein the rotor discs (R) are provided, comprising magnets in a pair number and different from the number of coils (102) in each stator disc (101) and arranged according to a regular polar sequence.

20. Alternator according to claim 14, comprising rotor discs (R) arranged in an angularly aligned position, i.e. each magnet of each rotor disc is positioned exactly above the corresponding magnet of the subsequent rotor disc and with a concordant orientation, so as to realize a polar distribution of linked axial magnetic fluxes alternated, in a number equal to that of the magnets in each polar series within each rotor disc, starting from the head rotor disc up to the tail rotor disc of the rotor stacking (200).

21. Alternator according to claim 14, wherein the three-phase alternated current (701) produced by each stator disc (P) is transformed in continuous current (304) with variable potential by a straightening bridge (303).

22. Alternator according to claim 21, wherein the continuous current (304) with variable potential of a sector of stator disc (P) is combined in series with the continuous current with variable potential of another sector of stator disc of the same stator disc (S).

23. Alternator according to claim 22, wherein the continuous current (304) with variable potential of a sector of stator disc (P) is combined in parallel with the continuous current (304) with variable potential of another sector of stator disc (101) of the same stator disc (S).
